(19) United States
(12) Patent Application Publication
(10) Pub. No.: US 2018/0149762 A1
(43) Pub. Date: May 31, 2018

(54) FLUORESCENT NUCLEAR TRACK DETECTORS AS CRITICALITY DOSIMETERS

(71) Applicant: Landauer, Inc., Glenwood, IL (US)

(72) Inventors: Mark S. Akselrod, Stillwater, OK (US); Jonathan Harrison, Stillwater, OK (US)

(21) Appl. No.: 15/828,354

(22) Filed: Nov. 30, 2017

Related U.S. Application Data
(60) Provisional application No. 62/428,525, filed on Nov. 30, 2016.

(51) Int. Cl. G01T 5/02; G01T 7/00

(52) U.S. Cl. CPC G01T 5/02; G01T 7/005

(57) ABSTRACT

A method of determining radiation exposure during a criticality excursion of a dosimeter having at least one fluorescent nuclear track detector (FNTD) element includes determining the power spectrum integral (PSI) value of the fluorescent images obtained from FNTD element at each of a plurality of different depths using laser induced fluorescent microscopy; normalizing the depth profile to the shallowest depth; fitting a double exponential function to the normalized depth profile; determining the median neutron energy from the E=f(1/e) function; and determining a neutron energy dose correction factor (NCF) from the NCF=f(E) function. The neutron dose, D, can then be calculated by dividing absolute value of the neutron-induced PSI by a sensitivity factor S and multiplying it by the neutron energy dose correction factor NCF.

### CROSS-REFERENCED APPLICATION

This application claims priority to U.S. provisional application Ser. No. 62/428,525 filed on Nov. 30, 2016. The disclosure of the above-referenced application is incorporated herein by reference in its entirety.

### FIELD

This disclosure relates to radiation dosimeters, and in particular to improvements in radiation dosimeters, and in the methods of reading radiation dosimeters.

### BACKGROUND

This section provides background information related to the present disclosure which is not necessarily prior art.

It is desirable for facilities where personnel can be exposed to large doses of radiation, such as those containing assemblies of fissile material larger than the minimum critical amount, to be capable of providing quick and accurate dosimetric information for personnel in the event of an incident, such as a criticality excursion.

Criticality dosimeters have a very specific set of requirements including those set forth in the International Atomic Energy (IAEA) Manual (1982) which are not easy to satisfy. Generally, these dosimeters have to provide measurements within relatively high total absorbed dose range for neutrons and gamma (0.1-10 Gy), good directional response, fast assessment of the dose after the event, as well as a high throughput measurement system. It usually also important to obtain the neutron energy information because both dosimeter response and the health effect of neutrons on humans is strongly dependent on the neutron energy. Each affected person may be exposed to a different dose and energy spectrum, depending upon their proximity to and angle with respect to the source, as well as the shielding between the person and the source.

Currently the most widely used dosimeters for this type of measurements are gold and indium activation foils and sulfur pellets, which generally require a complex gamma spectrometer and precise knowledge of the incidence time to correctly estimate the induced activity and neutron dose.

### SUMMARY

This section provides a general summary of the disclosure, and is not a comprehensive disclosure of its full scope or all of its features.

A preferred embodiment of this invention provides a method of determining radiation exposure during a criticality excursion of a dosimeter having at least one fluorescent nuclear track detector (FNTD) element. Generally this method of the preferred embodiment comprises determining the average of a special frequency power spectrum integral (PSI) values obtained by processing of the FNTD element images acquired at each of a plurality of different depths in the crystal using laser induced fluorescent microscopy. The depth profile is normalized to the shallowest depth. A double exponential function is used to fit the normalized depth profile. The median neutron energy is determined from the depth value corresponding to the decrease of normalized PSI value by e times (E=f (1/e) function). A neutron energy dose correction factor (NCF) is determined from another experimentally obtained function relating NCF and neutron energy E (NCF=f(E) function). Finally the neutron dose, D, is calculating by dividing the absolute value of the neutron-induced PSI by a sensitivity factor S and multiplying it by the neutron energy does correction factor NCF.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a photograph of loose FNTD single crystal chips with engraved ID numbers and an FNTD shown as it would be installed in the slide of a commercially available RadWatch™ radiation badge made of polyethylene with two other radiators/converters made of Teflon and Li-glass, and three round OSL sensors mounted in the slide;

FIG. 2 is a neutron spectra of each four mixed neutron-gamma fields used to irradiate FNTDs, including the BR1 reactor at the Belgian Nuclear Research Center (SCK-CEN); the Godiva-IV reactor of the U.S. Department of Energy National Criticality Experiments Research Centre (NCERC); the Fast Burst Reactor (FBR) at White Sands Missile Range; and AmBe neutron source at the Landauer calibration facilities in Glenwood, Ill.

FIG. 3 are examples of fluorescent confocal images of FNTDs a) under a PE converter and b) under a Teflon™ converter obtained at 2 μm depth after exposure of the FNTD crystal to 10 Gy of neutrons and 1 Gy of photons at FBR reactor at White Sands Missile Range;

FIG. 4 is a diagram showing a stack of sixteen fluorescent confocal images of the FNTD crystal area covered with polyethylene converter after exposure to 0.56 Gy Am Be neutrons;

FIG. 5 is a graph of experimental neutron-induced PSI signal depth profiles normalized to values obtained at the 2 um depth for the four different neutron sources;

FIG. 6 is a graph showing the determination of median energy of the neutron source from the 1/e depth of the normalized PSI signal;

FIG. 7 is a graph showing the determination of the neutron dose correction factor from the median neutron energy obtained from the FNTD signal depth profile;

FIG. 8. is a graph showing dose dependence of FNTD measurements for different sources using the neutron energy correction algorithm; and

FIG. 9 is a conceptual design of the criticality dosimeter holder with multiple facets having FNTD detectors installed at different angles with respect to incident neutron radiation.

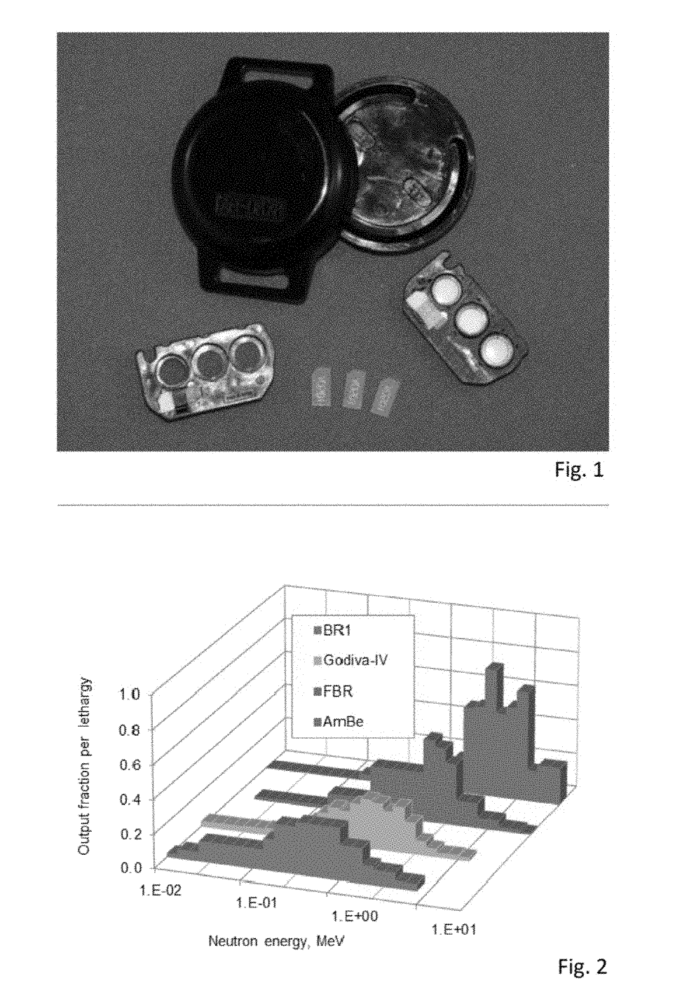

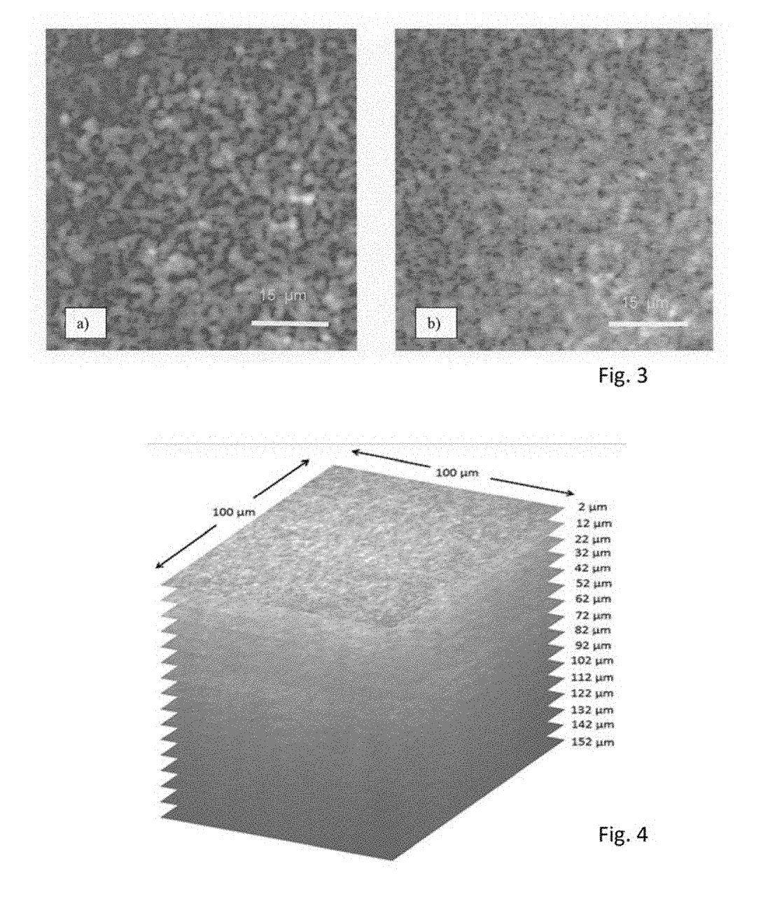

Corresponding reference numerals indicate corresponding parts throughout the several views of the drawings.

### DETAILED DESCRIPTION

Example embodiments will now be described more fully with reference to the accompanying drawings.

Recently developed Fluorescent Nuclear Track Detectors (FNTDs) based on Al₂O₃:C,Mg single crystals, when used in conjunction with appropriate measurement techniques, such as confocal laser scanning microscopy, are capable of measuring high doses of fast neutrons using a polyethylene converter and gamma doses using a Teflon™ converter. FNTDs are also capable of measuring thermal neutrons using a converter containing the ⁶Li isotope.

FNTDs are also capable of distinguishing different broad spectrum neutron fields for neutron doses at which tracks are individually distinguishable and can be counted. However, in cases where the tracks begin to overlap the spatial frequency power spectrum integral (PSI) of the acquired confocal fluorescent images is used instead to accurately measure the neutron dose.

The inventors have discovered that the depth profile of the analog parameter PSI can also be used to distinguish broad spectrum neutron fields according to their energy. A challenge for using FNTD technology in criticality dosimetry is its strong neutron energy dependence. However the inventors have found that the so-called converted dose values estimated from the PSI can be corrected by the neutron energy dependent correction factor to obtain the true absorbed neutron dose. In particular, the correct absorbed dose of neutrons can be measured by estimating the median neutron energy and corresponding energy dependent neutron dose correction factor directly from the FNTD measurements using the profile of the fluorescent signal as a function of depth in the crystal.

A dosimeter in accordance with the principles of this invention can be prepared from one or more FNTD crystals (Al₂O₃:C,Mg) having dimensions of 4 mm×8 mm×0.5 mm. One large side of each FNTD is preferably polished to optical quality and the other side is lapped and laser engraved with an ID. Each crystal can have some indicia of orientation, for example as shown one corner of the crystal is beveled to enable the identification of converter positions. The crystals are preferably subject to thermal enhancement and optical bleaching with pulsed UV laser to erase any residual dose and to reduce the background signal.

The FNTD crystals are preferably mounted in a dosimeter housing, for example in the slide of a RadWatch™ dosimeter, available from Landauer Inc. Each slide preferably has three standard converters: a polyethylene (PE) converter for fast neutrons; a Li-glass converter with natural ⁶Li content for detecting thermal neutrons; and a Teflon™ converter (or some other material that does not contain hydrogen) for measuring and subtracting the gamma-induced fluorescent signal. After an exposure, the FNTD crystals are removed from their dosimeter slides, and processed as described below.

### Example

To demonstrate the ability of FNTD technology to estimate neutron energy spectra neutron and gamma irradiations were performed at several facilities with well-known neutron spectral data. The irradiations were performed at four different facilities. At White Sands Missile Range (WSMR), the five FNTD dosimeters were exposed to 1 and 10 Gy of gamma and neutrons, respectively, from the Fast Burst Reactor (FBR). At the Belgian Nuclear Research Centre (SCK⋅CEN), five FNTD dosimeters at each dose were irradiated with 0.1, 1.34, 10, and 30 Gy of absorbed neutron dose inside the BR1 reactor cavity containing a natural metallic uranium sphere with a 6 cm thick wall and an inner radius of 14.25 cm. Several neutron doses in the range of 0.1 to 30 Gy were delivered at the dose rate of 9 mGy/s. Another batch of FNTD dosimeters was irradiated at the Godiva-IV reactor of the U.S. Department of Energy National Criticality Experiments Research Centre (NCERC). The reported dose values were provided by each of the reactor facilities and were typically obtained by a combination of simulations and activation dosimeters based on sulfur pellets or gold and indium activation foils. In the case of the Godiva-IV reactor Passive Bonner Sphere spectrometers were also used (Wilson et al, 2014).

AmBe neutron irradiations were performed at the Landauer calibration facilities at close proximity to the source to accumulate 0.56 Gy of neutron dose in a reasonable irradiation time. Additionally, five FNTD crystals per dose were exposed to 0.3 Gy, 1.5 Gy, 2 Gy, 10 Gy, and 30 Gy by a 137Cs gamma source at the Landauer, Inc. calibration facility in Glenwood, Ill. The neutron spectra of the four sources used at appropriate distances is shown in FIG. 2.

All FNTD crystals were read using a laser scanning confocal microscopy system, such as the FXR-700R, which is similar in design and operation to the commercially available FXR-700N reader produced by Landauer, Inc., except that it uses two galvanometers instead of one for the raster scanning of the laser-beam. The first galvanometer is still used for fast axis scanning to acquire fluorescent intensities in one direction, but the second galvanometer is used to translate the fast sweeping excitation beam across the detector surface perpendicular to the fast direction to acquire two-dimensional fluorescent images while the stage with mounted FNTDs remain stationary. Previously, this translation was performed by the stage motion. As in the one-galvanometer system, a piezo actuator is used to position the focused excitation beam at a desired depth in the crystal, but in the FXR-700R the piezo has a physical range of 250 microns instead of only 100 microns.

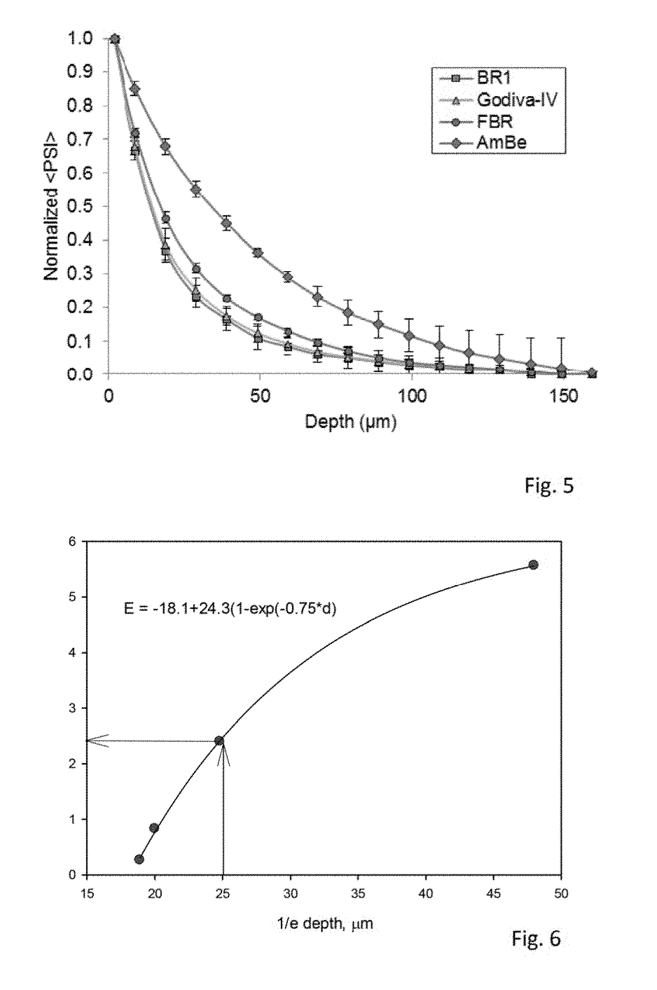

Fifty stacks, each stack consisting of sixteen 100×100 μm² image fields starting at two micron depth and spaced ten microns apart were scanned for the polyethylene and Teflon™ areas of each detector. Each image field was acquired in one second and was then processed according to the method described below thus producing a depth profile for each detector crystal. Results for all five FNTD crystals exposed to each of the neutron source were averaged and shown in FIG. 5. The reported error bars represent one standard deviation of the average values for the five detector crystals at each depth. The errors reported for AmBe are the square root of the sum of squares of standard deviations of the PSI values for the five FNTDs under a polyethylene converter and the five FNTDs under a Teflon™ converter. To minimize the overall size of the irradiated package the AmBe irradiation was performed not in slides but in a different configuration having five FNTDs fully covered and in direct contact with a Teflon™ substrate and another five FNTDs fully in direct contact with a PE substrate, so that the samples could be irradiated at a very close distance from the Am Be source to accumulate high dose in a reasonable time.

The inventors have found that several corrections must be applied to obtain reliable depth profile results. The first is a correction for spherical aberrations in the optical system of the reader at various depths of scanning that affects the focusing of the laser beam and the efficiency of collection of the fluorescent light. This can be done by measuring the depth profile of the PSI values of the fluorescent images collected under the PE converter of FNTD crystals irradiated with a high (10 Gy) dose of pure gamma covered by 5 mm of plastic. Because (1) the FNTD crystals are generally near electron equilibrium and (2) the energy deposition through 150 um depth of crystal is uniform, the gamma photon irradiation should result in a flat depth profile. Because of spherical aberrations of the reader optical system, however, the experimentally measured depth profile for gamma photons is not flat as a function of depths and the obtained PSI depth-profile function can be used for correcting the spherical aberrations of the optical system.

The second correction, which can be important to perform for relatively low doses (e.g., below 0.5 Gy) and low neutron energies, is the proper subtraction of the background signal for each area of the detector. This background signal depends on crystal coloration that is defined as a concentration of F₂²⁺(2Mg) color centers undergoing radiochromic transformation during irradiation. The coloration-dependent background for each area of each detector must be subtracted at each depth. For a gamma dose of 10 Gy this correction generally has a negligible effect on the aberration correction function described above.

Lastly, the signal from the Teflon™-covered areas of the crystal must be subtracted from the signal obtained from the PE-covered areas of the crystal to remove the gamma-induced signal at each depth. The remaining neutron-induced signal can then be normalized, for example to the signal obtained near the detector surface, to eliminate the variations in the intensity of the depth profile caused by the crystal coloration and the absorbed dose.

The experimental results of measurements of neutron-induced PSI values of FNTD crystals irradiated at four facilities with different neutron spectra are shown in FIG. 5. The depth profile for each neutron spectrum was normalized to the value obtained for the 2 μm depth point. The slopes of the depth profiles for the near-surface data points decreases as the median energy of the spectra increases similar to previous results obtained for track counting mode of FNTD operation (Sykora et al, 2009). The uncertainties for the AmBe experimental results are greater than those for the other spectra, and the inventors believe that this is because of lower doses of irradiation, the detectors' proximity to the source, and the resulting effect of the wide angular distribution of the incident neutrons.

The background PSI values for FNTDs irradiated in BR1 reactor cavity with the 6 cm U sphere in cavity and at Godiva-IV reactor were approximated by determining the PSI at 152 microns instead of calculating the background PSI from the coloration data as was done for FBR and Am Be because the PSI values for lower neutron energies were small and thus more sensitive to the experimental errors in the background estimations. The PSI value at 152 microns is used because SRIM calculations show that less than one percent of the recoil protons generated by each spectrum from these sources will penetrate to this depth. An additional annealing procedure after crystal growth may achieve better uniformity of the background signal between different areas of the crystal and as a result more precise fluorescent background subtraction which is generally more important at low dose levels.

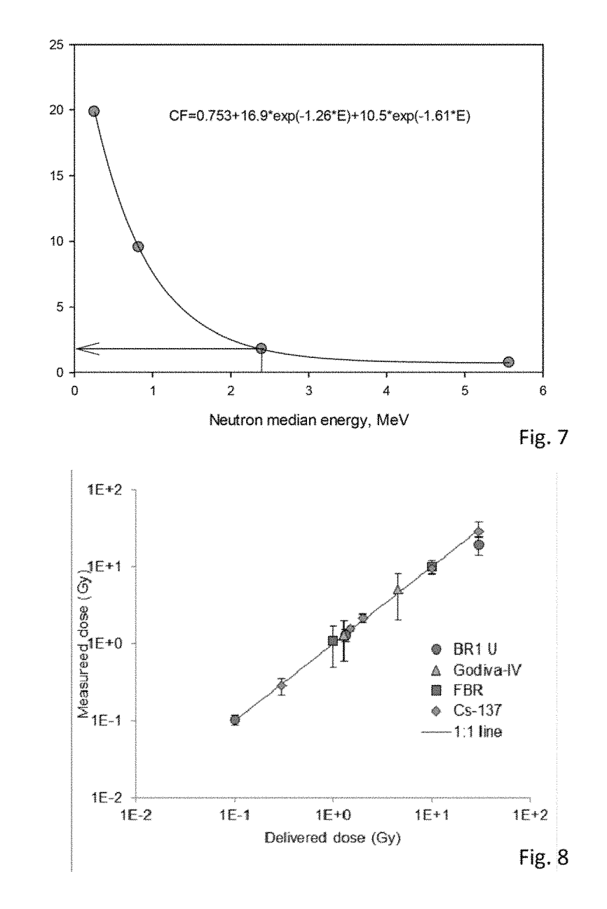

The normalized neutron-induced fluorescent signal depth profile shown in FIG. 5 was used to obtain the depth at which the PSI value was reduced e times (1/e depth in μm) and was then used to obtain a median energy of the neutron spectrum (FIG. 6). This estimated median energy was finally used to obtain a neutron energy correction factor (FIG. 7) that can be applied to the converted value (in photon dose equivalent units) obtained from the original PSI value at the smallest depth (2 μm) in the crystal. This neutron energy dose correction factor (NCF) also can be explained as gamma-to-neutron signal ratio (γ/n). At high median neutron energies from a source like Am Be this ratio was less than 1, whereas at low neutron energies, of, for example, the BR1 reactor, it was as high as 20 indicating a strong energy dependence of the FNTD crystals.

A preferred method of criticality dose determination would comprise these steps: Scanning the detector crystal covered by PE and Teflon converters at a plurality (e.g., 5 to 10 depths). Processing PSI values obtained from the images at each depth. Optionally, processing the PSI values using a correction function or factor to account for aberrations in the scanning process. Subtracting the Teflon PSI values from the PE PSI values. Normalizing the depth profile to the shallowest depth (e.g., the 2 μm depth point). Fitting a function to the depth profile (e.g., a double exponential curve). Determining the depth at which the PSI value reduced 1/e times. Determining the median neutron energy (e.g., from the E=f(1/e) function). Obtaining a neutron energy dose correction factor (e.g., from the NCF=γ/n=f(E) function). Finally, calculating the neutron dose, D, by dividing absolute value of the neutron-induced PSI obtained near the surface by the sensitivity factor S and multiplying it by the neutron energy correction factor NCF:

D=<PSI>*NCF/S (1)

PSI values are known to have good linearity as a function of both gamma and neutron doses The dose dependence for several neutron and photon sources was also investigated and the results after processing according to the above described method are shown in FIG. 8. The data for all irradiations show good linearity and correlation between the delivered and measured doses.

In the method described above a single median energy value is deduced from the measured normalized depth profiles. The median energy value might not, however, suffice to make a proper energy correction because detectors in general do not have a flat response in terms of energy or dose. Different neutron spectra might have the same median energy but a different detector response. In these instances, to make a proper correction it may be necessary to make a rough estimate of the energy spectrum. This can be possible by using several detectors with known energy response functions. In the case of the FNTD crystals, there are different neutron converters, e.g., PE and Li glass, and different depths, which can all be considered as different detectors with a certain energy response function. For example, a Li-glass converter would be useful for spectra with a dominant thermal neutron component. Its normalized depth profile would not be indicative of the neutron energy as all energy deposited by the alpha particles and tritium ions is released by the ⁶Li neutron capture reaction and thus independent of the incident neutron energy. Instead the absolute value of the average PSI under the Li-glass converter at a single depth would be used. Previous data obtained for track counting on mono-energetic neutrons, demonstrated that the track density ratio for PE and Li-based converters indicates the value of median neutron energy. Something similar should be done using the PE/Li-glass PSI ratio.

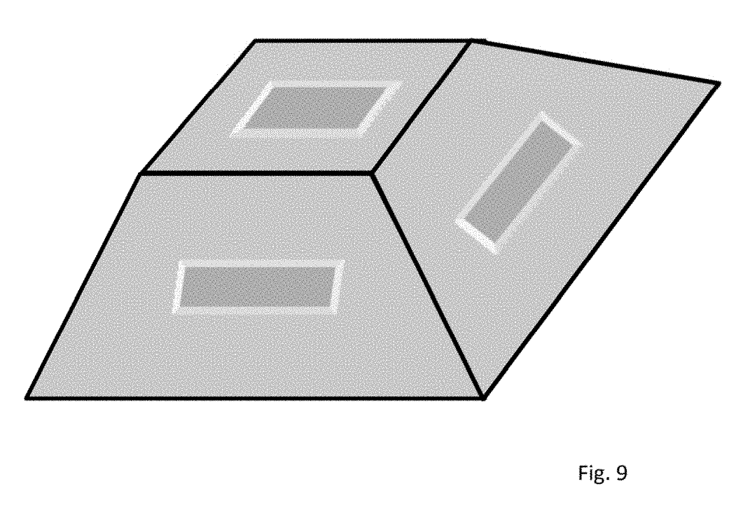

Another aspect of criticality dosimetry is the ability of the dosimetry system to determine the direction of the incident radiation. The strong angular dependence of most radiation detectors can cause big uncertainty in estimated neutron dose. FNTD crystals are very compact and multiple detectors can be measured relatively quickly. Thus dosimeter badges can be designed with the holder having multiple facets where multiple detectors are installed at different angles and that can provide necessary data to estimate the neutron incidence angle (FIG. 9).

According to a preferred embodiment of this invention normalized depth profiles of the neutron-induced signals from broad spectrum neutron fields obtained using FNTD crystals can be been used to estimate the median neutron energy, neutron dose correction factor, and finally the correct neutron dose. If desired, one of two means of background subtraction can be used: (1) the measured coloration and experimental function relating the crystal coloration and the residual background signal, or (2) measuring the signal at a depth beyond the deepest penetration of the highest energy neutron in the spectrum.

Thus, embodiments of this invention allow the median neutron energy of the broad neutron spectrum to be determined from the depth profile of fluorescent signal, for example by using a neutron energy correction factor determined as a function of median neutron energy, which in turn is determined from the fluorescent signal depth profile. This can be accomplished by reading the FNTD crystal using laser induced fluorescent microscopy technique at several depths in the crystal to obtain the fluorescent signal as a function of depth. As a calibration procedure the spherical aberration correction function of the FNTD reader optical system is obtained from the fluorescent signal depth profile of FNTDs irradiated in condition of electron equilibrium with pure high energy photons. This aberration correction function then used for processing the depth profile of fluorescent signal for detectors irradiated with mixed neutron and photon radiations. The FNTD crystals used are preferably covered by several different radiation convertors to discriminate and subtract the signal caused by photons from the fluorescent signal caused by both neutrons and photons.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of determining radiation exposure during a criticality excursion of a dosimeter having at least one FNTD element, the method comprising:
determining the PSI value of the FNTD element at each of a plurality of different depths using laser induced fluorescent microscopy;
normalizing the depth profile to the shallowest depth;
fitting a double exponential function to the normalized depth profile;
determining the median neutron energy from the E=f(1/e) function;
determining a neutron energy dose correction factor from the NCF=f(E) function; and
calculating the neutron dose, D, by dividing absolute value of the neutron-induced PSI by a sensitivity factor S and multiplying it by the neutron energy does correction factor NCF.

2. The method of determining radiation exposure according to claim 1, where a portion of the FNTD element is covered by polyethylene converter and a portion of the FNTD element is covered by polytetrafluoroethylene converter, and wherein the step of determining the PSI value comprising subtracting the PSI value measured behind the polytetrafluoroethylene converter from the PSI value measured behind the polyethylene converter.

3. A method of monitoring radiation exposure of a person in a space subjected to a criticality excursion, the method comprising:
providing the subject with a dosimeter including at least one FNTD element;
determining the radiation exposure of the dosimeter having at least one FNTD element, by:
determining the PSI value of the FNTD element at each of a plurality of different depths using laser induced fluorescent microscopy;
normalizing the depth profile to the shallowest depth;
fitting a double exponential function to the normalized depth profile;
determining the median neutron energy from the E=f(1/e) function;
determining a neutron energy dose correction factor from the NCF=f(E) function; and
calculating the neutron dose, D, by dividing absolute value of the neutron-induced PSI by a sensitivity factor S and multiplying it by the neutron energy does correction factor NCF.

4. The method according to claim 3 wherein the FNTD element is mounted in a badge and covered by at least one radiation convertor.

5. The method according to claim 4 wherein the dosimeter badge accommodates several FNTDs installed at different angles to obtain the information about the direction of incident radiation.

6. A method of correcting the spherical aberrations of the FNTD reader and obtaining the correction function by:
a) providing a dosimeter badge including at least one FNTD element mounted in a badge and covered by at least Teflon and polyethylene radiation convertors;
exposing the badge with high energy photons in condition of electron equilibrium;
reading the FNTD element using laser induced fluorescent microscopy technique at several depths in the crystal and obtaining the normalized depth profile of the PSI signal;
fitting the obtained experimental depth profile to a mathematical function and assign it as an aberration correction function to be used in FNTD dosimeter dose calculation algorithm.

7. A method of obtaining the value of a background PSI for each of the exposed FNTD elements by:
obtaining the neutron-induced PSI signal profile after subtraction of gamma photon-induced signal and correcting it for spherical aberrations of the optical system; and obtaining the PSI value at the depth beyond the maximum possible recoil proton penetration depth.

8. A method of monitoring radiation exposure of a person in a space subjected to a criticality excursion, the method comprising:
providing the subject with a dosimeter including at least one FNTD element mounted in a badge and covered by at least Teflon and polyethylene radiation convertors; and after the subject has been exposed to at least one type of radiation, reading the FNTD element using laser induced fluorescent microscopy technique at several depths in the FNTD element; processing PSI values of all images at each depth using an aberration correction function; subtracting the Teflon PSI values from the PE PSI values; normalizing the depth profile to the values of the shallowest depth point; fitting a double exponential function to the depth profile; determining the depth at which the PSI value reduced 1/e times; determining the median neutron energy from the E=f(1/e) function; obtaining the neutron energy dose correction factor from the NCF=f(E) function; and calculating the neutron dose, D, by dividing absolute value of the neutron-induced PSI by the sensitivity factor S and multiplying it by the neutron energy correction factor NCF.
